(19) United States
(12) Patent Application Publication
(10) Pub. No.: US 2009/0059636 A1
(43) Pub. Date: Mar. 5, 2009

(54) POWER ADAPTER HAVING AN ELECTRICITY STORING CAPABILITY

(75) Inventors: Lien-Hsun HO, Taipei (TW); Yuan-Liang HSU, Taipei (TW)

Correspondence Address: PATENTTM.US, P. O. BOX 82788, PORTLAND, OR, 97282-0788, US

(73) Assignee: CYBER POWER SYSTEM INC., Taipei (TW)

(21) Appl. No.: 11/847,243

(22) Filed: Aug. 29, 2007

(51) Int. Cl. H02M 1/00; H02J 9/00

(52) U.S. Cl. 363/146; 307/66

(57) ABSTRACT

A power adapter has a body, a pair of blades, a DC output terminal, an AC to DC circuit, a node and a storage unit. The blades are mounted in and protrude from the body to connect to an AC power source to obtain AC power. The DC output terminal is mounted on the body to connect to a load. The AC to DC circuit is mounted in the body, converts the AC power into DC power and has an input terminal and an output terminal. The node is defined between the DC output terminal and the AC to DC circuit. The storage unit is connected to the node to store the DC power output from the AC to DC circuit and provide a stored DC output to the DC output terminal.

### BACKGROUND OF THE INVENTION

1. Field of the Invention

The present invention relates to a power adapter, and more particularly to a power adapter having an electricity storing capability.

2. Description of Related Art

Electrical devices and appliances are designed with a digital circuit, and the electrical devices and appliances use DC power and therefore require a conventional power adapter.

With reference to FIG. 6, the conventional power adapter comprises a casing (70), a pair of blades (71), an AC to DC circuit and a power cord (72). The blades (71) are used to electrically connect to an AC power source to obtain AC power. The AC to DC circuit is mounted in the casing (70) and is connected to the blades (71) to convert the AC power into DC power. The power cord (72) is mounted in and protrudes from the casing (70) and is electrically connected to the AC to DC circuit and provides DC power to the electrical device or appliance.

However, the electrical device or appliance does not work without the AC power source because the conventional power adapter only converts the AC power directly into DC power.

To overcome the shortcomings, the present invention provides a power adapter having an electricity storing capability to mitigate or obviate the aforementioned problems.

### SUMMARY OF THE INVENTION

The main objective of the invention is to provide a power adapter that has an electricity storing capability.

A power adapter in accordance with the present invention comprises a body, a pair of blades, a DC output terminal, an AC to DC circuit, a node and a storage unit. The blades are mounted in and protrude from the body to connect to an AC power source to obtain AC power. The DC output terminal is mounted on the body to connect to an electronic device or appliance. The AC to DC circuit is mounted in the body, converts the AC power into DC power and has an input terminal and an output terminal. The node is defined between the DC output terminal and the AC to DC circuit. The storage unit is connected to the node to store the DC power output from the AC to DC circuit and provide a stored DC power to the DC output terminal.

Other objectives, advantages and novel features of the invention will become more apparent from the following detailed description when taken in conjunction with the accompanying drawings.

### BRIEF DESCRIPTION OF THE DRAWINGS

FIG. 1 is a schematic of a first embodiment of a power adapter in accordance with the present invention;

FIG. 2 is a schematic of a second embodiment of a power adapter in accordance with the present invention;

FIG. 3 is a schematic of a third embodiment of a power adapter in accordance with the present invention;

FIG. 4 is a schematic of a fourth embodiment of a power adapter in accordance with the present invention;

FIG. 5 is a schematic of a fifth embodiment of a power adapter in accordance with the present invention; and

FIG. 6 is a perspective view of a conventional power adapter.

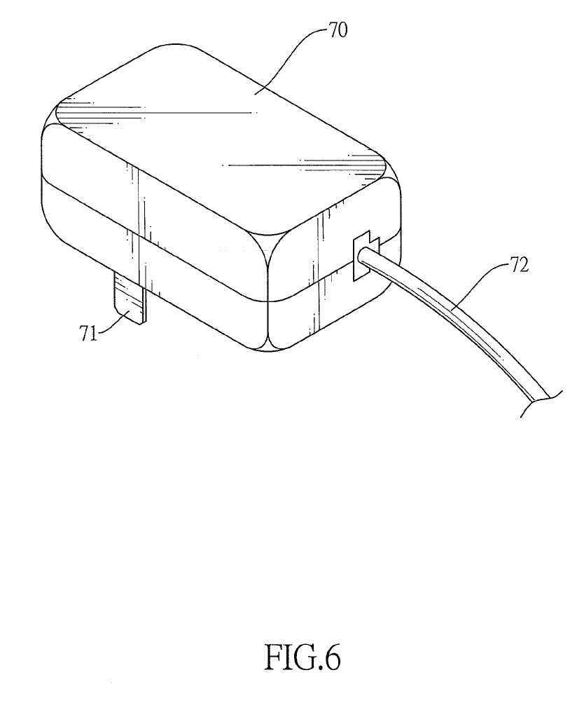

### DETAILED DESCRIPTION OF PREFERRED EMBODIMENT

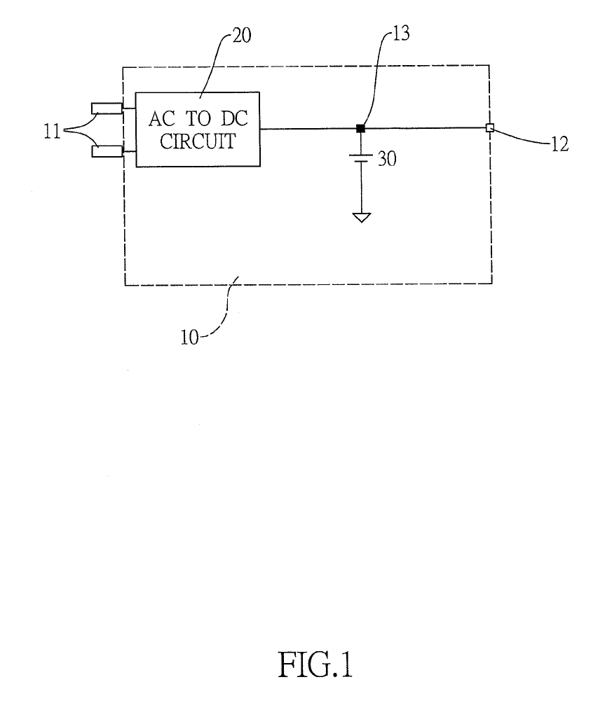

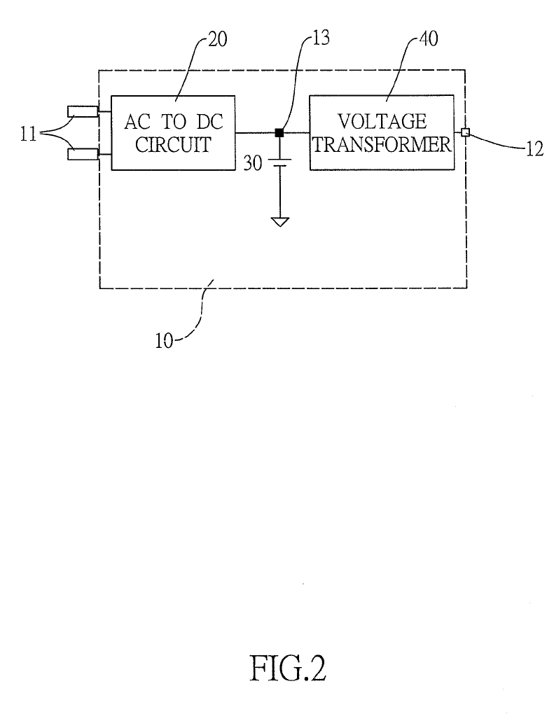

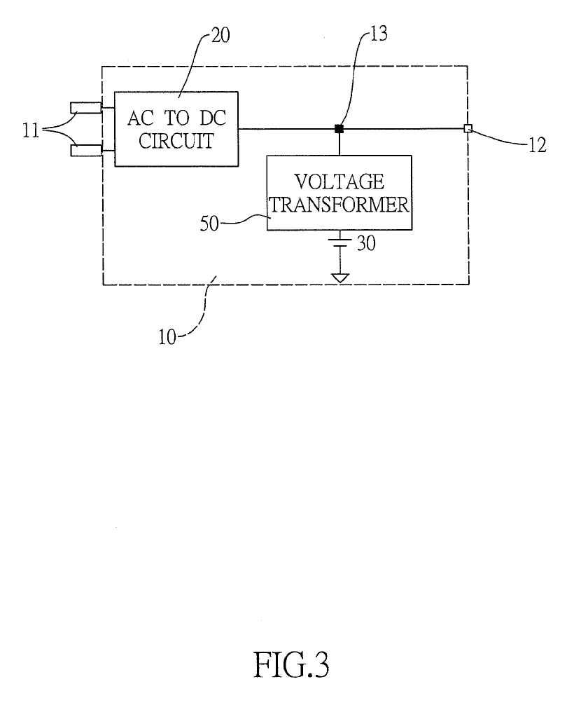

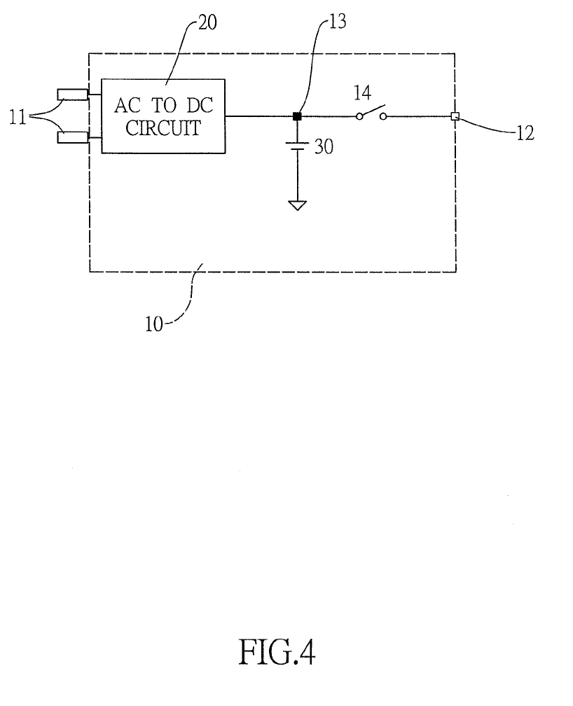

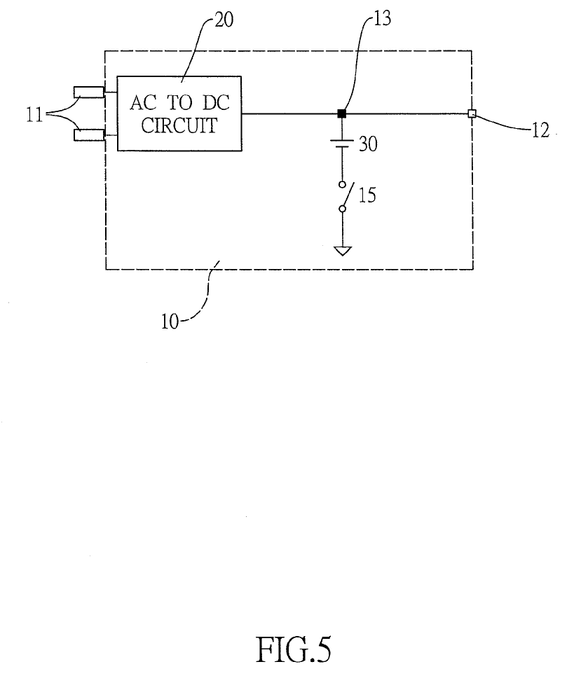

With reference to FIGS. 1 to 5, a power adapter in accordance with the present invention comprises a body (10), a pair of blades (11), a DC output terminal (12), an AC to DC circuit (20), a node (13), a storage unit (30), an optional voltage transformer (40) and an optional switch (14).

The blades (11) are mounted in and protrude from the body (10) to connect to an AC power source to obtain AC power.

The DC output terminal (12) is mounted on the body (10) to connect to a load, such as an electronic device or appliance.

The AC to DC circuit (20) is mounted in the body (10), has an input terminal and an output terminal and converts the AC power into DC power. The input terminal is connected to the blades (11) to obtain the AC power. The output terminal is connected to the DC output terminal (12).

The node (13) is defined between the DC output terminal (12) and the AC to DC circuit (20).

The storage unit (30) may be a battery and is connected to the node (13) to store the DC power output from the AC to DC circuit (20) and provide a stored DC power to the DC output terminal (12).

The voltage transformer (40) may be connected between the DC output terminal (12) and the node (13) or between the node (13) and the storage unit (30) to transform the DC power by stepping up, stepping down or stepping up and stepping down the DC power.

When the voltage transformer (40) is connected between the DC output terminal (12) and the node (13), the voltage transformer (40) transforms the DC power output from the AC to DC circuit (20) and the stored DC output from the storage unit (30) to the DC output terminal (12).

When the voltage transformer (40) is connected between the node (13) and the storage unit (30), the voltage transformer (40) transforms the DC power output from the AC to DC circuit (20) to the storage unit (30) and the stored DC output from the storage unit (30) to the DC output terminal (12).

The switch (14) may be connected between the DC output terminal (12) and the node (13) or between the storage unit (30) and ground.

When the switch (14) is connected between the DC output terminal (12) and the node (13), opening and closing the switch (14) determines whether the AC to DC circuit (20) and the storage unit (30) output the DC power and the stored DC power to the DC output terminal (12).

When the switch (14) is connected between the storage unit (30) and ground, opening and closing the switch (14) determines whether the storage unit (30) stores the DC power and provides the DC power.

The described power adapter has the storage unit (30) storing the DC power when the AC power source is active. When the AC power source is inactive, the storage unit (30) will provide the stored DC power to the electronic device or appliance through the DC output terminal (12) and allow the electronic device or appliance to continue functioning.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A power adapter having an electricity storing capability comprising:
a body;
a pair of blades being mounted in and protruding from the body to connect to an AC power source to obtain AC power;
a DC output terminal being mounted on the body to connect to a load;
an AC to DC circuit being mounted in the body, converting the AC power into DC power and having
an input terminal connected to the blades to obtain the AC power; and
an output terminal connected to the DC output terminal;
a node defined between the DC output terminal and the AC to DC circuit; and
a storage unit connected to the node to store the DC power output from the AC to DC circuit and provide a stored DC power to the DC output terminal.

2. The power adapter as claimed in claim 1 further comprising a voltage transformer connected between the DC output terminal and the node to transform the DC power output from the AC to DC circuit and the stored DC output from the storage unit to the DC output terminal.

3. The power adapter as claimed in claim 1 further comprising a voltage transformer connected between the node and the storage unit to transform the DC power output from the AC to DC circuit to the storage unit and the stored DC output from the storage unit to the DC output terminal.

4. The power adapter as claimed in claim 1 further comprising a switch connected between the DC output terminal and the node and being opened and closed to determine whether the AC to DC circuit and the storage unit output the DC power and the stored DC power to the DC output terminal.

5. The power adapter as claimed in claim 1 further comprising a switch connected between the storage unit and ground and being opened and closed to determine whether the storage unit stores and provides the DC power.

6. The power adapter as claimed in claim 2, wherein the voltage transformer steps up the DC power.

7. The power adapter as claimed in claim 2, wherein the voltage transformer steps down the DC power.

8. The power adapter as claimed in claim 2, wherein the voltage transformer steps up and down the DC power.

9. The power adapter as claimed in claim 3, wherein the voltage transformer steps up the DC power.

10. The power adapter as claimed in claim 3, wherein the voltage transformer steps down the DC power.

11. The power adapter as claimed in claim 3, wherein the voltage transformer steps up and down the DC power.

12. The power adapter as claimed in claim 1, wherein the storage unit is a battery.

13. The power adapter as claimed in claim 2, wherein the storage unit is a battery.

14. The power adapter as claimed in claim 3, wherein the storage unit is a battery.

15. The power adapter as claimed in claim 4, wherein the storage unit is a battery.

16. The power adapter as claimed in claim 5, wherein the storage unit is a battery.
